(19) United States
(12) Patent Application Publication
(10) Pub. No.: US 2013/0158817 A1
(43) Pub. Date: Jun. 20, 2013

(54) CONTROLLING A BOWL OF A SCRAPER

(71) Applicants: Ryan Kingdon, Peoria, IL (US); Erik Eddington, Bartonville, IL (US); Eric Polston, Peoria, IL (US); Steven Krause, Chillicothe, IL (US); Ramona Cone, Countryside, IL (US); Brian Byers, Decatur, IL (US); Keith Kosowski, Peoria, IL (US)

(72) Inventors: Ryan Kingdon, Peoria, IL (US); Erik Eddington, Bartonville, IL (US); Eric Polston, Peoria, IL (US); Steven Krause, Chillicothe, IL (US); Ramona Cone, Countryside, IL (US); Brian Byers, Decatur, IL (US); Keith Kosowski, Peoria, IL (US)

(73) Assignee: Caterpillar Inc., Peoria, IL (US)

(21) Appl. No.: 13/331,835

(22) Filed: Dec. 20, 2011

(51) Int. Cl. E02F 3/65; G06F 19/00

(52) U.S. Cl. 701/50

(57) ABSTRACT

A method for controlling a bowl of a scraper is disclosed. The method includes receiving a signal from an input device, the signal is indicative of a mode of operation of the scraper, determining a cycle of operation of the scraper associated with the mode of operation, and controlling the bowl based in part on a sequence of parameter settings generated by a control system. The control system is configured to generate the sequence of parameter settings based in part on the cycle of operation of the scraper.

### TECHNICAL FIELD

The present disclosure relates generally to systems and methods for controlling a scraper and, more particularly, to systems and methods for automatically controlling a bowl of the scraper.

### BACKGROUND

Machines, such as, tractor scrapers, typically include a tractor connected to a bowl including a blade configured to engage and excavate material from a surface of terrain as the scraper traverses the surface. The tractor and the bowl may include fraction devices, such as wheels, that provide support on the surface. An operator may control the direction and speed of the scraper as it traverses the surface. The blade may be located at a forward position of the bowl and proximate to the surface. The operator may control the position of the bowl relative to the surface to control the engagement of the blade with the surface. For example, by lowering the bowl and driving the tractor over the surface, the operator may engage the blade with the surface to dislodge material from the surface and to load the dislodged material into the bowl as the tractor traverses the surface.

In addition, the operator may control the position of the bowl relative to the surface to allow for transportation of and subsequent unloading of the material accumulated in the bowl as a result of the engagement between the blade and the surface. For example, after the operator loads the bowl to its capacity, the operator may raise the bowl and transport the material to a different location to unload or dump the material. In other words, the operator must be able to move the bowl between an elevated driving or hauling position, a lower loading, and an unloading position that may be between the driving, hauling and loading positions. In addition, the operator must control various components associated with the bowl while the scraper is being used to perform various operations such as loading, hauling, and unloading.

U.S. Pat. No. 6,336,068 (“the '068 patent”) issued to Lawson et al. discloses a control system to automate operations for wheel tractor scrapers. The control system simplifies the operation of the wheel tractor scraper by automating the many operations of the wheel tractor scraper which alleviates the operator from many of the operations of the wheel tractor scraper during the use thereof. The control system has a load control module, a haul control module associated with the load control module and an eject control module. The eject control module is associated with the load control module and the haul control module. The load control module, the haul control module and the eject control module control the loading, hauling and unloading operations of the wheel tractor scraper.

The present disclosure is directed to overcoming one or more of the shortcomings set forth above.

### SUMMARY OF THE INVENTION

In one aspect, the present disclosure is directed to a method for controlling a bowl of a scraper. The method includes receiving a signal from an input device, the signal is indicative of a mode of operation of the scraper, determining a cycle of operation of the scraper associated with the mode of operation, and controlling the bowl based in part on a sequence of parameter settings generated by a control system. The control system is configured to generate the sequence of parameter settings based in part on the cycle of operation of the scraper.

### BRIEF DESCRIPTION OF THE DRAWINGS

FIG. 1 is a diagrammatic illustration of a machine including a control system in accordance with an embodiment of the present disclosure;

FIG. 2 is a schematic illustration of an embodiment of the control system of FIG. 1; and

FIG. 3 is a flow diagram illustrating an embodiment of a control process configured to be performed by the control system of the present disclosure.

### DETAILED DESCRIPTION

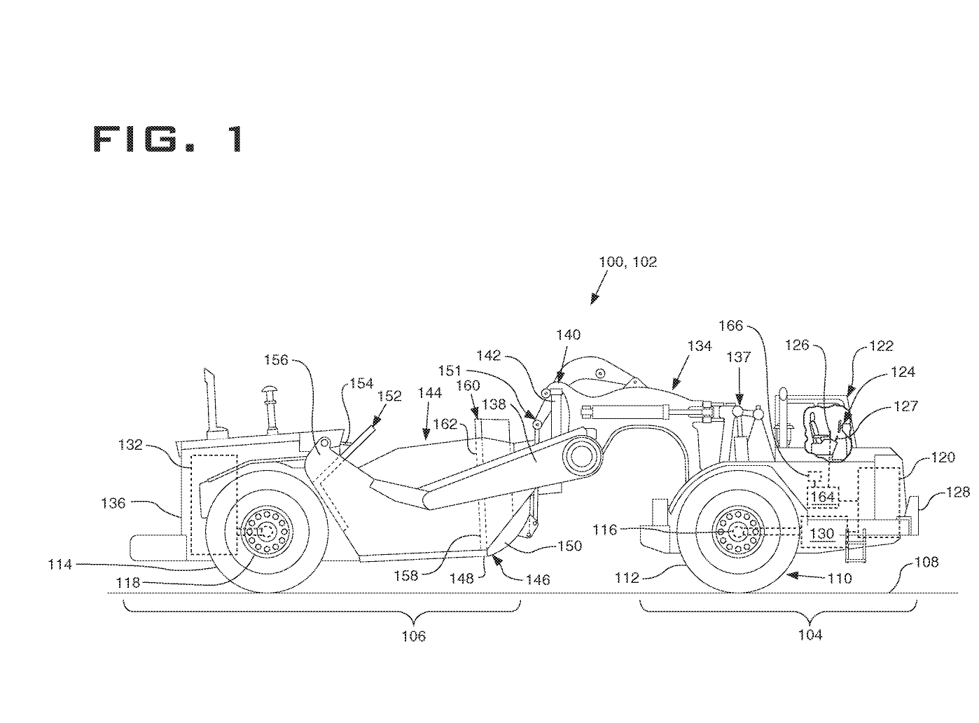

This disclosure relates to systems and methods for controlling a scraper bowl adapted for automatically adjusting the bowl while loading the bowl, hauling material in the bowl, unloading material from the bowl, and returning the bowl to a default operational state. An exemplary embodiment of a machine 100 is generally shown in FIG. 1, which may perform operations associated with industries such as mining, construction, farming, transportation, or any other industry. Specifically, the machine 100 may be embodied as a scraper 102, or any other material loading and/or material handling machine adapted to load material at a first location, transport the material from the first location to a second location, and unload the material at the second location. The scraper 102 may be of various sizes, such as, for example with varying power and capacity characteristics, and a choice of scraper 102 may depend on an excavating operation to be performed.

Further, the scraper 102 may operate in cycles or modes of operations, such as, for example, a loading mode, a hauling mode, an unloading mode, and a returning mode. The modes of operations may be affected by various parameters and/or factors and may as a result embody various cycle characteristics affecting machine performance, productivity, and operating costs. In addition, the scraper 102 may have settings or configurations corresponding to or associated with each mode of operation. For example, the loading mode may be associated with a ready to dig configuration, the hauling mode may be associated with a ready to haul configuration, the unloading mode may be associated with a ready to eject configuration, and the returning mode may be associated with a ready to return to a default configuration.

In an illustrated embodiment, the scraper 102 includes a tractor portion 104 operatively connected to a bowl portion 106. The scraper 102 is adapted or configured to move the bowl portion 106 across a terrain or ground surface 108 of material, such as, for example earth. In some embodiments, the scraper 102 may include systems and components that are operatively connected to provide power and control operations to the bowl portion 106. The tractor portion 104 and the bowl portion 106 are supported by ground engaging or traction devices 110, which embody a pair of front wheels 112 and a pair of rear wheels 114 (only one side shown).

Although the scraper 102 may be commonly referred to as a wheel tractor scraper or wheeled tractor scraper, it is contemplated that the traction devices 110 may additionally or alternately include tracks, belts, or other traction mechanisms adapted to propel the scraper 102 across the surface 108. It is also contemplated that the traction devices 110 may be hydraulically controlled, mechanically controlled, electronically controlled, or controlled in any other suitable manner. The traction devices 110 may include one or more driven components, such as an axle, and one or more non-driven components. In the illustrated embodiment, the fraction devices 110 include a front axle assembly 116 and a rear axle assembly 118. The driven components may be operatively connected to a power source, such as, for example, an engine 120, by any conventional arrangement including, for example, a drive train, differential gear transfers, and/or other suitable mechanisms, to receive mechanical power and provide movement to the fraction devices 110.

The scraper 102 further includes an operator station or cab 122, which may include controls necessary to operate the scraper 102, such as, for example, input devices 124 for propelling the scraper 102 and/or for controlling the bowl portion 106 and/or for controlling other machine components. The input devices 124 may include one or more devices embodied as a joystick 126 disposed within the cab 122 and may be adapted to receive input from an operator (not shown) indicative of a desired movement of the bowl portion 106 or a desired movement of the scraper 102 relative to the surface 108. The input devices 124 may also include one or more devices embodied as a keypad 127 disposed within the cab 122 and may be adapted to receive input from the operator indicative of an operation associated with a movement of the bowl portion 106 or a movement of the scraper 102.

The cab 122 is mounted on a tractor frame 128, which may also be adapted to support the engine 120. The engine 120 may embody, for example, a diesel engine, a gasoline engine, a gaseous fuel-powered engine, or any other type of combustion engine known in the art. It is contemplated that the power source may alternatively embody a non-combustion source of power (not shown) such as, for example, a fuel cell, a power storage device, or another suitable source of power. The engine 120 may produce a mechanical or electrical power output that may be converted to hydraulic power, for example, to provide electrical and/or hydraulic power to the bowl portion 106.

The engine 120 is operatively connected to a transmission 130 adapted to drive the front wheels 112 through the front axle assembly 116 and thereby move or pull the scraper 102 across the surface 108. In some embodiments, the scraper 102 may include an additional power source 132 adapted to drive the rear wheels 114 through the rear axle assembly 118 and thereby move or push the scraper 102 across the surface 108. In some embodiments, the transmission 130 may embody an electric transmission, a hydraulic transmission, a mechanical transmission, or a hybrid transmission and may be adapted to include a selectable reverse gear ratio and a plurality of selectable forward gear ratios correlating to a ratio of input to output speed of the transmission 130.

The scraper 102 further includes a hitch assembly 134 that may operatively connect the tractor portion 104 to the bowl portion 106. The hitch assembly 134 may be disposed between the tractor frame 128 and a bowl frame 136. In some embodiments, the hitch assembly 134, tractor frame 128, and bowl frame 136, may include movable and/or fixed linkages and/or other structural components, in any dimensions, and may be pivotal with respect to one another to allow relative movement between the tractor portion 104 and the bowl portion 106, such as, for example, in vertical and horizontal directions.

The hitch assembly 134 may include structural and hydraulic components that may allow selective movement of the bowl portion 106 in isolation from the operator station 122. In addition, the hitch assembly 134 may be selectively controllable to control pitch and bounce when the scraper 102 is transporting material, such as during the hauling mode of operation. For example, when the scraper 102 is in the loading mode of operation, the hitch assembly 134 is adapted to be in a locked state or a no suspension state. In the illustrated embodiment, the hitch assembly 134 includes a cushion hitch assembly 137 that is adapted to be selectively moveable between an unlocked or suspension state and the locked or no suspension state. When in the locked or no suspension state, the cushion hitch assembly 137 is lowered, for example, hydraulically lowered and locked down. The operator may selectively lock and unlock the cushion hitch assembly 137 during the different modes of operation of the scraper 102 to affect the controllability of the scraper 102 driving over varying conditions and terrains of the surface 108.

In the illustrated embodiment, the hitch assembly 134 further includes a pair of arms 138 each located on opposing sides of the scraper 102 (only one side shown). One or more actuators 140 may be disposed between the hitch assembly 134 and may be operatively connected to the bowl portion 106. The one or more actuators 140 may include a piston-cylinder arrangement, a hydraulic motor, and/or any other known actuator having one or more fluid chambers therein. For example, the one or more actuators 140 may embody a piston-cylinder assembly and a hydraulic system (not shown) may selectively supply and drain pressurized fluid from one or more chambers within the cylinder to affect movement of a piston-rod assembly (not shown).

The expansion and retraction of the one or more actuators 140 may function to affect movement of the bowl portion 106 relative to the surface 108. The pressure of the fluid within a chamber may be influenced by the amount of pressurized fluid directed toward the chamber and the amount of resistance a load may apply against actuator movement. For example, a hydraulic system may selectively direct pressurized fluid from a source of pressurized fluid, such as, for example, a pump, toward one or more chambers and selectively direct pressurized fluid to from one or more chambers to a tank through one or more valves to extend and retract the piston rod. In some embodiments, however, the one or more actuators 140 may not embody a cylinder arrangement but some other hydraulic arrangement, such as, a hydraulic motor arrangement, and/or may not be a hydraulic actuator and, as such, a non-hydraulic system, such as, for example, a gear train, rack and pinion system, linkage, and/or other mechanisms that may affect the extension and retraction of the one or more actuators 140.

In the illustrated embodiment, the one or more actuators 140 embody a pair of hydraulic cylinders 142 (only one side shown) operatively connected to the bowl portion 106 and configured to selectively raise the bowl portion 106 away from the surface 108 or lower the bowl portion 106 toward the surface 108 by retracting and extending the cylinders 142. The bowl portion 106 includes a bowl 144 operatively connected to the bowl frame 136 and supported by the rear wheels 114. The bowl 144 is generally embodied as an enclosure or container that includes an end portion defining an opening 146 and a cutting edge or blade 148 adjacent to or proximate to the opening 146.

During operation, the bowl 144 may be caused to pivot about the rear axle assembly 118 by extending or retracting the one or more actuators 140 to raise or lower the blade 148 of the bowl 144 relative to the surface 108. In some embodiments, during the loading mode of operation the blade 148 may be configured to penetrate the surface 108 to disturb or disrupt the material of the surface 108 as a function of the position of bowl 144. For example, the blade 148 may engage the surface 108 to scoop, slice, tear, rake, and/or perform any other such task. A depth of cut of the blade 148, such as, for example, the distance below surface 108 that the blade 148 penetrates, may be selectively and controllably adjusted by the actuation of the one or more actuators 140.

For example, the blade 148 may be pivoted downward about the rear axle assembly 118 to engage the blade 148 with the surface 108. The blade 148 may be configured to dislodge or remove material from surface 108 and load the dislodged material in to the bowl 144 through the opening 146 as the scraper 102 moves across the surface 108. An extension of the cylinders 142 may affect the depth of the blade 148 cut into the surface 108 and consequently an amount of dislodged material loaded into the bowl 144.

In addition, a travel speed of the scraper 102 may affect a rate of removal of material and a rate of loading the removed material into the bowl 144. In other words, the amount of material that may accumulate is a function of the depth of cut of blade 148, the speed of scraper 102, and/or the material characteristics. For example, the loaded material may accumulate faster with a deeper depth of cut, a higher speed, and softer material as compared with a shallower depth of cut, lower speed, and/or harder material, respectively. In some embodiments, the loaded material may include any type of and/or mixtures of material, such as, for example, soil, aggregate, sand, clay and may include any material properties, such as, for example, hard, soft, rocky, compacted, wet, and/or dry.

In some embodiments, the scraper 102 may include a plurality of bowl portions or bowls (not shown) operatively connected to each other. In the illustrated embodiment, the bowl portion 106 further includes an apron 150 adapted to selectively close off the opening 146 of the bowl 144 to allow material to be stored and transported in the bowl 144 without undesired spillage, such as, for example, during the hauling mode of operations. The apron 150 may be pivotally connected to the bowl 144 and adapted to move pivotally relative to the bowl 144 from an open position to a closed position. In some embodiments, the apron 150 may include mechanical and hydraulic components, such as hydraulic cylinders 151 to move the apron 150 between the open and closed positions. In some embodiments, the apron 150 may be adapted to be selectively moved and maintained or held in a float state between the open and closed positions. Movement of the apron 150 may include setting the apron 150 to a height position that may be intermediate to a fully open or a fully closed position relative to the opening 146 of the bowl 144. The height position may be preset by the operator.

In some embodiments, the bowl portion 106 may additionally, or alternatively, include other components, such as, an elevator or conveyor configured to assist in loading and unloading the bowl 144, for example, an augur attachment, and/or an ejector. In the illustrated embodiment, the bowl portion 106 includes an ejector 152 adapted to be moveable during the modes of operations of the scraper 102. The ejector 152 may be adapted to be suitably shaped or with suitable geometric characteristics to satisfactorily fit within the bowl 144 or to be an integral portion of the bowl 144 to perform desired functions, such as, for example, pushing or unloading material from the bowl 144 during the unloading mode of operation.

The ejector 152 may be further adapted to selectively move accumulated material or payload within the bowl 144 out through the opening 146 when the apron 150 is in the open position. The ejector 152 may be adapted to selectively move accumulated material when the apron 150 is in a position in between the closed position and the open position. For example, the ejector 152 may be adapted to initiate movement when the apron 150 is approximately seventy five percent open relative to one hundred percent open, which is essentially commensurate with being in the open position, or zero percent open, which is essentially commensurate with being in the closed position.

The bowl portion 106 includes an ejector cylinder 154 connected between the ejector 152 and the bowl frame 136 of bowl portion 106. The ejector 152 may be moved by the ejector cylinder 154 from a refracted state or a full retract position adjacent to or at an end portion 156 of the bowl 144 to an extended state or a full unload position adjacent to or at a front portion 158 of the bowl 144. The ejector 152 may be selectively moveable during the unloading mode of operation. When the ejector 152 is away from the full unload position, material may be loaded into bowl 144 through the opening 146 and/or transported within bowl 144, such as during the hauling mode of operation. When the ejector 152 is moved toward the full unload position, material accumulated within bowl 144 may be pushed out of the opening 146.

The ejector cylinder 154 may be selectively provided with and drained of pressurized fluid to cause the ejector cylinder 154 to retract to the retracted state and to extend to the extended state, thereby moving the ejector 152 between the full retract position and the full unload position. In some embodiments, the ejector 152 and the apron 150 may be adapted to operate synchronously during the unload mode such that, for example, the ejector 152 is adapted to move based on an operational status of the apron 150. In some embodiments, the ejector cylinder 154 may be equipped with a pressure sensor (not shown) configured to sense a pressure of the ejector cylinder 154 and to generate a corresponding signal. The signal generated by the pressure sensor may be indicative of a position of ejector 152. For example, when the ejector cylinder 154 reaches stops (not shown) associated with the full retract and full unload positions, corresponding pressure differences within the ejector cylinder 154 may provide an indication as to the position of ejector cylinder 154 and ejector 152.

In some embodiments, when the ejector cylinder 154 is between the full retract and full unload positions, the signal generated by the pressure sensor may be related to or representative of a load or amount of accumulated material being moved by the ejector 152 and the ejector cylinder 154. For example, when a pressure within the ejector cylinder 154 is less than a threshold amount, the pressure sensor may generate a signal indicating that the ejector 152 is being moved in an unloaded or low load state. Alternatively, when a pressure within the ejector cylinder 154 is more than a threshold amount, the pressure sensor may generate a signal indicating that the ejector 152 is being moved in a loaded state. In the illustrated embodiment, when pressure is approximately equal to a threshold on a rod-end or head-end of the pressure sensor, the ejector 152 may be determined to be fully forward or fully rearward respectively. Alternatively, when there is not a pressure spike and cylinder 154 is moving, the ejector 152 may be determined to be in an unknown state.

In some embodiments, the bowl portion 106 of the scraper 102 further includes a load assist unit 160 associated with the bowl 144 such as, for example, an auger or an elevator. In the illustrated embodiment, the load assist unit 160 is embodied as an elevator 162 that assists with the loading of material or payload into the bowl 144. The elevator 162 is disposed within the bowl 144 and approximate to or adjacent to the blade 148 and opening 146 of the bowl 144. The elevator 162 may be driven by an actuator and/or a hydraulic motor (not shown). In some embodiments, the elevator 162 is pivotably or rotatably connected to the bowl 144 and is adapted be selectively operated in an on mode and an off mode. In addition, a speed of movement associated with the elevator 162, for example, rotational movement of the elevator 162, may be selectively increased or decreased.

The elevator may be adapted to operate during the loading and unloading modes of operation. For example, the elevator 162 is adapted to selectively move rotationally in either a forward direction or forward direction state and in a reverse direction or a reverse direction state. During the loading mode, the elevator 162 is in the on mode and a forward direction state and thus may carry or push material from the blade 148 rearwardly and upwardly into the bowl 144. During the unloading mode, the elevator 162 is in the on mode and a reverse direction state and may be adapted to carry or push material forwardly and downwardly out of the bowl 144 through the opening 146. Alternatively, or additionally, the elevator 162 may be in the off mode and not moving in either the forward or reverse direction, but instead may be adapted to function as a forward wall positioned in the front portion 158 of the bowl. In embodiments including the elevator 162, the apron 150 may not be included.

The scraper 102 may further include a control system 164 operatively connected to the input devices 124, to the one or more actuators 140 for controlling, for example, movement of the blade 148 of the bowl 144, and other hydraulic actuators. In some embodiments, the control system 164 may be operatively connected to the input devices 124 and to other components for controlling other operations of the scraper 102, such as, for example, operatively connected to the traction devices 110 for controlling a speed of the scraper 102. In some embodiments, the control system 164 may be adapted to cause the scraper 102 to be operated in a manual mode responsive to an operator's desired movement of the bowl 144, such as, for example, by control of the joystick 126. In some embodiments, the control system 164 may be adapted to cause the scraper 102 to operate in an automatic mode responsive to signals automatically generated by the control system 164 for controlling movement of the bowl 144.

In the manual mode, the control system 164 may direct the blade 148 of the bowl 144 to move to a target position in response to an operator's desired movement of the blade 148 for engaging the blade 148 with the surface 108. Additionally, or alternatively, in the automatic mode, the control system 164 may further direct the blade 148 of the bowl 144 to move to a target position indicative of an automatically determined movement of the blade 148, based at least in part on, for example, an algorithm, an engineering or site design, a data map, a productivity measure, or a combination of algorithm, site design, data map, and productivity measure.

The control system 164 may include one or more sensors 166 operatively connected to or associated with the scraper 102 for sensing and determining certain operational characteristics. The one or more sensors 166 may be provided throughout the scraper 102 and at least one of the one or more sensors 166 may be located proximate to or adjacent to the transmission 130, the hitch assembly 134, the bowl 144, the actuators 140, 142, the apron 150, the ejector 152, the ejector cylinder 154, or the load assist unit 160.

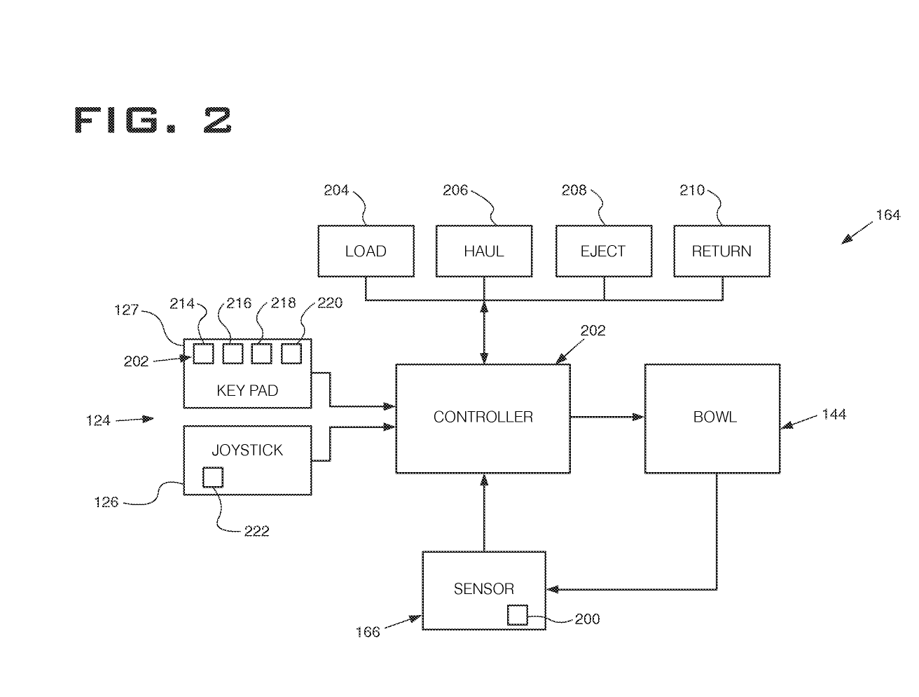

An embodiment of the control system 164 is shown schematically in FIG. 2. In some embodiments, the control system 164 may send a command to one or more components of the scraper 102 in response to signals collected and transmitted from the one or more sensors 166. The control system 164 may receive sensor signals directly from the one or more sensors 166 or indirectly, such as, for example, from a data link or other communication interface. In some embodiments, the one or more sensors 166 may measure, collect, and transmit signals to the control system 164 indicative of a speed of the scraper 102, such as, for example, a ground speed of the scraper 102. In some embodiments, the sensors 166 may each selectively include a plurality of sensors each establishing a plurality of signals and that each plurality of signals may be combinable into a common signal. The sensors 166 may embody any type of sensor, such as, for example, hall effect sensors, global positioning signals (GPS), infrared or radar speed sensors.

Further, the one or more sensors 166 may embody one or more cylinder position sensors 200 associated with the one or more actuators 140, the hydraulic cylinders 142, 151, and/or the ejector cylinder 154. The sensors 166 may include any conventional sensor configured to establish a signal as a function of a sensed physical parameter. The cylinder position sensors 200 may be configured to sense or determine whether the hydraulic cylinders 142, 151, 154 are fully extended or fully retracted or within a range of extension and refraction indicative of vertical movement of the bowl 144 relative to the surface 108 and additionally, or alternatively, movement of the bowl 144 relative to the scraper 102.

In one embodiment, the control system 164 may include one or more controllers 202 configured to control operations of the scraper 102 during the loading, hauling, unloading, and returning modes of operation. The one or more controllers 202 may be configured to receive a plurality of inputs, for example, signals generated by the one or more of sensors 166 and/or input devices 124 to perform a plurality of functional relations, for example, algorithms, equations, subroutines, look-up maps, tables, and/or comparisons, to determine or generate an output and thus influence or affect the operation of the bowl 144. In some embodiments, the control system 164 may include one or more data structure, such as, for example, one or more data maps, which may include two dimensional arrays or lookup tables, in memory. The maps may contain data in the form of equations, tables, or graphs.

As shown in FIG. 2, the one or more controllers 202 may include a load controller 204, a haul controller 206, an eject controller 208, and a return controller 210. The one or more controllers 202 may also be configured to provide information associated with parameters and/or settings that are used to control operations of the scraper 102 during the loading, hauling, unloading, and returning modes of operations. For example, the one or more controllers 202 may update the control system 164 to calibrate the scraper 102 and/or to preset parameters or settings associated with one or more scraper components, such as, for example, the gears (not shown) of the transmission 130, the blade 148 of the bowl 144, the apron 150, the hitch assembly 134, the ejector 152, and/or the elevator 162.

The one or more controllers 202 may be configured to control the scraper 102 when the scraper 102 is in any one of the four modes of operations: the loading operation mode, the hauling operation mode, the unloading operation mode, and the returning operation mode. The one or more controllers 202 may be further configured to control the scraper 102 when the scraper is transitioning from one mode of operation to a next mode of operation or between modes of operations. The control system 164 may automate the four modes of operation through the one or more controllers 202, namely, the load controller 204 for controlling the scraper 102 during the loading operation mode, the haul controller 206 for controlling the scraper 102 during the hauling operation mode, the eject controller 208 for controlling the scraper during the unloading operation mode, and the return controller 210 for controlling the scraper 102 during the returning operation mode.

The one or more controllers 202 may further automate the modes of operations by controlling the transmission 130, the hitch assembly 134, the actuators 140, 142, the bowl 144, the apron 150, the ejector 152, the ejector cylinder 154, or the load assist unit 160. The specific mode of operation may be activated by an operator through the one or more input devices 124, such as, for example through a toggle switch, push button, or other activating mechanism. In the illustrated embodiment, the keypad 127 includes one or more buttons 212 operatively connected to the one or more controllers 202. The one or more buttons 212 may be configured to interact with the one or more controllers 202 to transmit information, data, commands, and/or signals to the control system 164 and to control operations of the scraper 102 during the modes of operations.

The control system 164 may be adapted to receive inputs from the input devices 124, such as, for example, input signals from the one or more buttons 212 of the keypad 127 that may be indicative of an operator activation of the load controller 204, haul controller 206, eject controller 208, and the return controller 210 for enabling the control system 164 to activate the automatic mode and/or to establish the parameter settings associated with each of the cycles of operations. In some embodiments, the one or more buttons 212 may embody separate and individual buttons associated with each of the cycles of operations configured to activate the parameter settings for each of the cycles of operations. For example, the one or more buttons 212 may embody a ready to dig button 214, a ready to haul button 216, a ready to unload button 218, and a ready to return button 220.

The control system 164 may also be adapted to receive inputs from the joystick 126 that may be indicative of an activate a cycle of operation mode button 222 for selectively placing the control system 164 into the automatic mode of operation and/or for establishing the parameter settings for each of the cycles of operations, just as discussed above for the one or more buttons 212. Instead of an individual button for each of the cycles of operation, the cycle of operation mode button 222 may toggle through each of the cycles of operations and accordingly activate the load controller 204, the haul controller 206, the eject controller 208, and the return controller 210.

The control system 164 is further adapted to control or direct the movement of the blade 148 based at least in part on the inputs from the input devices 124 and the one or more sensors 166. Consequently, the control system 164 can determine a position of the blade 148. With the position of the blade 148 and other such information associated with operations of the scraper 102, the control system 164 may control the operations of the scraper 102 as discussed above, such as, for example controlling a depth of cut or penetration of the blade 148 in the surface 108. Additionally, or alternatively, the operator may engage the joystick 126 to produce a signal indicative of the operator's desire to affect manual control of bowl 144. In some embodiments, input devices 124 may embody, for example, multi-axis joysticks, knobs, push-pull devices, switches, keyboards, keypads, touch-screens, displays, and/or other operator interface devices.

In some embodiments, the control system 164 may include one or more control modules (e.g. ECMs, ECUs, etc.). The one or more controllers 202 may each include one or more control modules. The one or more control modules may include processing units, memory, sensor interfaces, and/or control signal interfaces (for receiving and transmitting signals). The processing units may represent one or more logic and/or processing components used by the control system 164 to perform certain communications, control, and/or diagnostic functions. For example, the processing units may be adapted to execute routing information among devices within and/or external to the control system 164.

Further, the processing units may be adapted to execute instructions, including from a storage device, such as memory. The one or more control modules may include a plurality of processing units, such as one or more general purpose processing units and or special purpose units (for example, ASICS, FPGAs, etc.). In certain embodiments, functionality of the processing unit may be embodied within an integrated microprocessor or microcontroller, including integrated CPU, memory, and one or more peripherals. The memory may represent one or more known systems capable of storing information, including, but not limited to, a random access memory (RAM), a read-only memory (ROM), magnetic and optical storage devices, disks, programmable, erasable components such as erasable programmable read-only memory (EPROM, EEPROM, etc.), and nonvolatile memory such as flash memory.

### INDUSTRIAL APPLICABILITY

This disclosure relates to systems and methods for controlling a scraper bowl adapted for automatically adjusting the bowl while loading the bowl, hauling material in the bowl, unloading material from the bowl, and returning the bowl to a default operational state. The industrial applicability of the systems and methods for controlling the movement of the bowl described herein will be readily appreciated from the foregoing discussion. Although the machine 100 is shown as a scraper 102, the machine 100 may be any type of machine 100 that performs at least one operation associated with, for example, mining, construction, and other industrial applications.

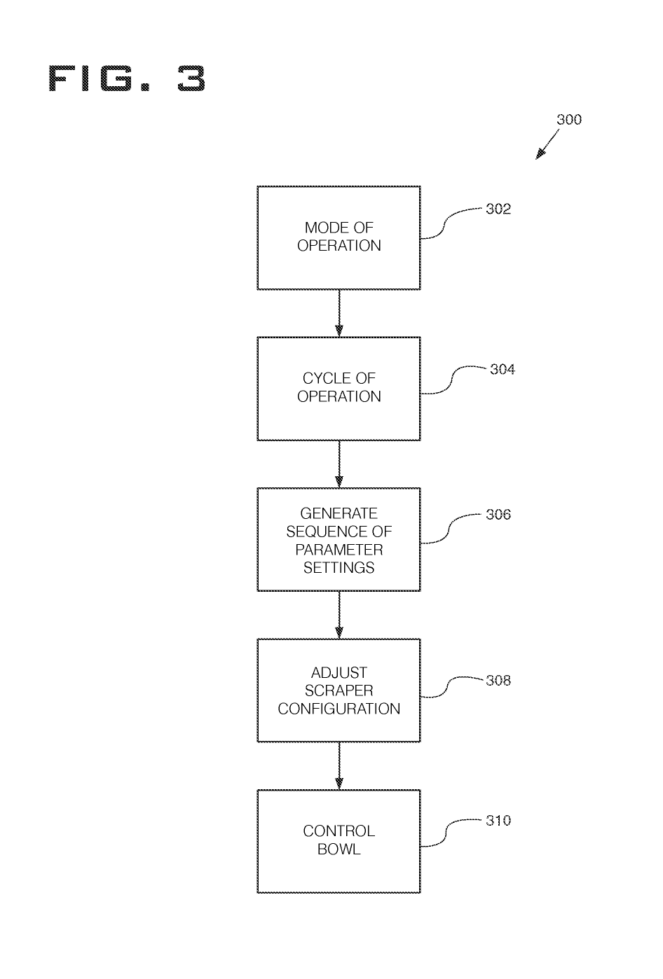

As discussed, one exemplary machine 100 suited to the disclosure is the scraper 102. In accordance with certain embodiments, FIG. 3 illustrates an exemplary embodiment of the control system 164 and the process of controlling the movement of the scraper bowl 144 (300). The control system 164 may be adapted to receive a signal or command indicative of an engagement of the one or more buttons 212 embodied as sequence assist buttons associated with the keypad 127 to selectively provide the control system 164 with the appropriate software or computer instructions to implement the control process (300) and for controlling the movement of the bowl 144.

The control system 164 may receive a signal indicative of the mode of operation of the scraper (Step 302). The mode of operation may be one of the loading operation mode, the hauling operation mode, the unloading operation mode, or the returning operation mode, as discussed in more detail above. Based on the mode of operation, the control system 164 may determine a cycle of operation that may have settings or configurations corresponding to or associated with each mode of operation (Step 304). For example, the loading mode may be associated with a ready to dig configuration, the hauling mode may be associated with a ready to haul configuration, the unloading mode may be associated with a ready to eject configuration, and the returning mode may be associated with a ready to return to a default configuration.

The control system 164 is further configured to generate a sequence of parameter settings based at least in part on the cycle of operation of the scraper 102 (Step 306). The sequence of parameter settings may be associated with at least one of a bowl parameter setting or a load assist unit parameter setting. For example, depending on a type of or model of scraper 102, the scraper 102 may or may not have the load assist unit 160. In one embodiment, the model of scraper 102 that includes the elevator 162 is commonly referred to or generally known as an elevating scraper. If the model of scraper 102 has the load assist unit 160 embodied as the elevator 162, that is, the elevating scraper, then the sequence of parameter settings may be embodied as the load assist unit parameter settings. Additionally, or alternatively, in one embodiment, the model of scraper 102 does not include the elevator 162 and is commonly referred to or generally known as an open bowl scraper 102.

The open bowl scraper 102 may or may not include the load assist unit 160 embodied as an auger (not shown). If the model of scraper 102 does not include the elevator 162, that is, the open bowl scraper 102, then the sequence of parameter settings may be embodied as the bowl parameter setting. In some embodiments of the open bowl scraper 102, the bowl parameter setting may include at least one of a transmission parameter, a hitch parameter, an ejector parameter, an apron parameter, or a blade position parameter and the control system 164 may be configured to adjust the transmission 130 according to the transmission parameter, the hitch assembly 134 according to the hitch parameter, the blade 148 according to the blade position parameter, the apron 150 according to the apron parameter, and/or the ejector 152 according to the ejector parameter.

In some embodiments of the elevating scraper 102, the load assist parameter setting may include at least one of the transmission parameter, the hitch parameter, the ejector parameter, the elevator parameter or the blade position parameter and the control system 164 may be configured to adjust the transmission 130 according to the transmission parameter, the hitch assembly 134 according to the hitch parameter, the blade 148 according to the blade position parameter, the ejector 152 according to the ejector parameter, and/or the elevator 162 according to the elevator parameter.

Based on the determined mode of operation and the associated cycle of operation, the control system 164 is configured to adjust the configuration of the scraper 102 accordingly (Step 308). In one embodiment, when the mode of operation is the loading mode of operation, the cycle of operation associated with the loading mode is the ready to dig configuration. For the open bowl scraper 102, the control system 164 is configured to generate the following corresponding sequence of parameter settings in parallel or in sequence. The control system 164 establishes a desired gear as the transmission parameter. The transmission 130 is accordingly locked in the desired gear. In some embodiments, the desired gear is a second gear. In other embodiments, the desired gear is a third gear; nevertheless, other desired gears are contemplated.

The control system 164 further establishes a state of the cushion hitch assembly 137 as the hitch parameter, the ejector 152 as the ejector parameter, the apron 150 as the apron parameter, and the position of the blade 148 as the blade position parameter. The cushion hitch assembly 137 is locked or in the no suspension state, if not already in the locked or the no suspension state. The ejector 152 if not fully retracted is moved to the retracted state or the full retract position. The apron 150 is moved to an open position, if not already in the open position. Finally, the control system 164 moves the bowl 144 to a target position, which may be based in part on the blade position parameter corresponding to the mode of operation (Step 310), in this case based on the loading mode of operation.

For the elevating scraper 102, the control system 164 is configured to generate the following corresponding sequence of parameter settings in parallel or in sequence while in the ready to dig cycle of operation associated with the loading mode of operation. The control system 164 establishes the desired gear as the transmission parameter and the transmission 130 is accordingly locked in the desired gear (as discussed above in open bowl scraper embodiment). The cushion hitch assembly 137 is locked or in the no suspension state, if not already in the locked or the no suspension state. The ejector 152 if not fully retracted is moved to the retracted state or the full retract position. The state of the elevator 162 is established as the elevator parameter. The elevator 162 is turned to the on mode and in the forward direction state, causing the elevator 162 to move rotationally forward, if not moving forward already. The control system 164 moves the bowl 144 to a target position, which may be based in part on the blade position parameter corresponding to the mode of operation (Step 310), in this case based on the loading mode of operation.

In one embodiment, when the mode of operation is the hauling mode of operation, the cycle of operation associated with the hauling mode is the ready to haul configuration. For the open bowl scraper 102, the control system 164 is configured to generate the following corresponding sequence of parameter settings in parallel or in sequence. The control system 164 establishes no desired gear as the transmission parameter and the transmission 130 is accordingly unlocked.

The control system 164 further establishes the state of the cushion hitch assembly 137 as the hitch parameter, the apron 150 as the apron parameter, and the position of the blade 148 as the blade position parameter. The cushion hitch assembly 137 is unlocked or in the suspension state, if not already in the unlocked or the suspension state. The apron 150 is moved to the closed position, if not already in the closed position. Finally, the control system 164 moves the bowl 144 to a target position, which may be based in part on the blade position parameter corresponding to the mode of operation (Step 310), in this case based on the hauling mode of operation.

For the elevating scraper 102, the control system 164 is configured to generate the following corresponding sequence of parameter settings in parallel or in sequence while in the ready to haul cycle of operation associated with the hauling mode of operation. The control system 164 establishes no gear as the transmission parameter and the transmission 130 is accordingly unlocked (as discussed above in open bowl scraper embodiment). The cushion hitch assembly 137 is unlocked or in the suspension state, if not already in the unlocked or the suspension state. The state of the elevator 162 is established as the elevator parameter. The elevator 162 is turned to the off mode. The control system 164 moves the bowl 144 to a target position, which may be based in part on the blade position parameter corresponding to the mode of operation (Step 310), in this case based on the hauling mode of operation.

In one embodiment, when the mode of operation is the unloading mode of operation, the cycle of operation associated with the unloading mode is the ready to unload configuration. For the open bowl scraper 102, the control system 164 is configured to generate the following corresponding sequence of parameter settings in parallel or in sequence. The control system 164 moves the bowl 144 to a target position, which may be based in part on the blade position parameter corresponding to the mode of operation (Step 310), in this case based on the unloading mode of operation. In some embodiments, this blade position parameter is established first in the sequence and the bowl 144 is accordingly moved to the target position first.

The apron 150 is moved to an open position, if not already in the open position. The ejector 152 if not fully extended is moved to the extended state or the full unload position. As discussed above, the ejector 152 may be adapted to selectively move based on a position of the apron 150, for example, when the apron 150 is in a position in between the closed position and the open position.

For the elevating scraper 102, the control system 164 is configured to generate the following corresponding sequence of parameter settings in parallel or in sequence while in the ready to unload cycle of operation associated with the unloading mode of operation. The control system 164 moves the bowl 144 to the target position based on the blade position parameter corresponding to the mode of operation (Step 310), in this case based on the unloading mode of operation. Again, this blade position parameter may be established first in the sequence and the bowl 144 is accordingly moved to the target position first. The elevator 162 is turned to the on mode and in the reverse direction state, causing the elevator 162 to move rotationally rearward, if not moving rearwardly already. The ejector 152 if not fully extended is moved to the extended state or the full unload position.

In one embodiment, when the mode of operation is the returning mode of operation, the cycle of operation associated with the returning mode is the ready to return configuration. For the open bowl scraper 102, the control system 164 is configured to generate the following corresponding sequence of parameter settings in parallel or in sequence. The cushion hitch assembly 137 is unlocked or in the suspension state, if not already in the unlocked or the suspension state. The apron 150 is moved to the open position, if not already in the open position. The control system 164 moves the bowl 144 to a target position, which may be based in part on the blade position parameter corresponding to the mode of operation (Step 310), in this case based on the returning mode of operation. Finally, the ejector 152 if not fully retracted is moved to the retracted state or the full retract position.

For the elevating scraper 102, the control system 164 is configured to generate the following corresponding sequence of parameter settings in parallel or in sequence. The cushion hitch assembly 137 is unlocked or in the suspension state, if not already in the unlocked or the suspension state. The control system 164 moves the bowl 144 to a target position, which may be based in part on the blade position parameter corresponding to the mode of operation (Step 310), in this case based on the returning mode of operation. The elevator 162 is turned to the off mode, if not already off. Finally, the ejector 152 if not fully retracted is moved to the retracted state or the full retract position.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A method for controlling a bowl of a scraper, the method comprising:
receiving a signal from an input device, wherein the signal is indicative of a mode of operation of the scraper;
determining a cycle of operation of the scraper associated with the mode of operation; and
controlling the bowl based in part on a sequence of parameter settings generated by a control system, wherein the control system is configured to generate the sequence of parameter settings based in part on the cycle of operation of the scraper.

2. The method of claim 1, wherein the cycle of operation is associated with at least one of a loading mode of operation, a hauling mode of operation, an unloading mode of operation, or a returning mode of operation.

3. The method of claim 2, wherein the sequence of parameter settings is associated with a bowl parameter setting.

4. The method of claim 2, wherein the sequence of parameter settings is associated with at least one of a bowl parameter setting or a load assist unit parameter setting.

5. The method of claim 4, wherein the at least one of a bowl parameter setting or a load assist unit parameter setting includes at least one of a transmission parameter, a hitch parameter, an ejector parameter, an elevator parameter, an apron parameter, or a blade position parameter; and wherein the control system is configured to adjust a transmission according to the transmission parameter, a hitch assembly according to the hitch parameter, an ejector according to the ejector parameter, an elevator according to the elevator parameter, an apron according to the apron parameter, or a blade position according to the blade position parameter.

6. The method of claim 5, wherein the control system is configured to set the at least one of a bowl parameter setting or a load assist unit parameter setting when the cycle of operation is associated with the loading mode of operation, wherein the control system is configured accordingly to set at least one of the transmission parameter to a locked gear state, the hitch parameter to a no suspension state, the ejector parameter to a retracted state, the elevator parameter to a forward position state, the apron parameter to an open state, and the blade position parameter to a target load position.

7. The method of claim 6, wherein the control system is configured to set the at least one of a bowl parameter setting or a load assist unit parameter setting when the cycle of operation is associated with hauling mode of operation, wherein the control system is configured accordingly to set at least one of the transmission parameter to an unlocked gear state, the hitch parameter to a suspension state, the elevator parameter to an off position state, the apron parameter to a closed state, and the blade position parameter to a target haul position.

8. The method of claim 7, wherein the control system is configured to set the at least one of a bowl parameter setting or a load assist unit parameter setting when the cycle of operation is associated with unloading mode of operation, wherein the control system is configured accordingly to set at least one of the ejector parameter to a fully forward state, the elevator parameter to a reverse position state, the apron parameter to an unload open state, and the blade position parameter to a target unload position.

9. The method of claim 8, wherein the control system is configured to adjust the ejector according to the ejector parameter and the apron parameter, wherein adjusting the ejector is responsively based on a position of the apron relative to a previous position of the apron.

10. The method of claim 8, wherein the control system is configured to set the at least one of a bowl parameter setting or a load assist unit parameter setting when the cycle of operation is associated with returning mode of operation, wherein the control system is configured accordingly to set at least one of the hitch parameter to the suspension state, the ejector parameter to the retracted state, the elevator parameter to the off position state, the apron parameter to the open state, and the blade position parameter to a target return position.

11. A control system for a scraper including an input device operatively connected between the control system and a bowl of the scraper, the control system comprising:
a controller operatively connected to the bowl, the controller configured to:
receive a signal indicative of a mode of operation of the scraper;
determine a cycle of operation of the scraper associated with the mode of operation; and
control the bowl based in part on a sequence of parameter settings generated by the controller, wherein the sequence of parameter settings is based in part on the cycle of operation of the scraper.

12. The system of claim 11, wherein the cycle of operation is associated with at least one of a loading mode of operation, a hauling mode of operation, an unloading mode of operation, or a returning mode of operation.

13. The system of claim 12, wherein the sequence of parameter settings is associated with at least one of a bowl parameter setting or a load assist unit parameter setting.

14. The system of claim 13, wherein the at least one of a bowl parameter setting or a load assist unit parameter setting includes at least one of a transmission parameter, a hitch parameter, an ejector parameter, an elevator parameter, an apron parameter, or a blade position parameter; and wherein the controller is configured to adjust a transmission according to the transmission parameter, a hitch assembly according to the hitch parameter, an ejector according to the ejector parameter, an elevator according to the elevator parameter, an apron according to the apron parameter, or a blade position according to the blade position parameter.

15. The system of claim 14, wherein the controller is configured to set the at least one of a bowl parameter setting or a load assist unit parameter setting when the cycle of operation is associated with the loading mode of operation, wherein the controller is configured accordingly to set at least one of the transmission parameter to a locked gear state, the hitch parameter to a no suspension state, the ejector parameter to a retracted state, the elevator parameter to a forward position state, the apron parameter to an open state, and the blade position parameter to a target load position.

16. The system of claim 15, wherein the controller is configured to set the at least one of a bowl parameter setting or a load assist unit parameter setting when the cycle of operation is associated with hauling mode of operation, wherein the controller is configured accordingly to set at least one of the transmission parameter to an unlocked gear state, the hitch parameter to a suspension state, the elevator parameter to an off position state, the apron parameter to a closed state, and the blade position parameter to a target haul position.

17. The system of claim 16, wherein the controller is configured to set the at least one of a bowl parameter setting or a load assist unit parameter setting when the cycle of operation is associated with unloading mode of operation, wherein the controller is configured accordingly to set at least one of the ejector parameter to a fully forward state, the elevator parameter to a reverse position state, the apron parameter to an unload open state, and the blade position parameter to a target unload position.

18. The system of claim 17, wherein the controller is configured to adjust the ejector according to the ejector parameter and the apron parameter, wherein adjusting the ejector is responsively based on a position of the apron relative to a previous position of the apron.

19. The system of claim 17, wherein the controller is configured to set the at least one of a bowl parameter setting or a load assist unit parameter setting when the cycle of operation is associated with the returning mode of operation, wherein the controller is configured accordingly to set at least one of the hitch parameter to the suspension state, the ejector parameter to the retracted state, the elevator parameter to the off position state, the apron parameter to the open state, and the blade position parameter to a target return position.

20. A scraper comprising:
at least one bowl including a blade adapted to separate material from the surface;
at least one input device adapted to responsively transmit a signal indicative of a mode of operation; and
a control system operatively connected between the at least one bowl and the at least one input device, the control system configured to receive signals from the at least one input device, the control system further configured to:
receive the signal indicative of the mode of operation of the scraper;
determine a cycle of operation of the scraper associated with the mode of operation, wherein the cycle of operation is associated with at least one of a loading mode of operation, a hauling mode of operation, an unloading mode of operation, or a returning mode of operation; and
control the bowl based in part on a sequence of parameter settings generated by the control system, wherein the sequence of parameter settings is based in part on the cycle of operation of the scraper, and the sequence of parameter settings is associated with at least one of a bowl parameter setting or a load assist unit parameter setting, and wherein the at least one of a bowl parameter setting or a load assist unit parameter setting includes at least one of a transmission parameter, a hitch parameter, an ejector parameter, an elevator parameter, an apron parameter, or a blade position parameter; and wherein the controller is configured to adjust a transmission according to the transmission parameter, a hitch assembly according to the hitch parameter, an ejector according to the ejector parameter, an elevator according to the elevator parameter, an apron according to the apron parameter, or the blade according to the blade position parameter.
